(19) United States
(12) Patent Application Publication
(10) Pub. No.: US 2008/0094478 A1
(43) Pub. Date: Apr. 24, 2008

(54) Image capture and display devices, methods, and computer readable media

(75) Inventor: Hitoshi Sato, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/907,869

(22) Filed: Oct. 18, 2007

(30) Foreign Application Priority Data
Oct. 18, 2006 (JP) 2006-284127

(51) Int. Cl. H04N 5/232

(52) U.S. Cl. 348/208.12; 348/333.12; 348/E05.045

(57) ABSTRACT

An image capture device according to the present invention includes: an image capture unit that captures an image; a focus control unit that controls a to-be-focused position of the capture unit; a display unit that displays the image; an area specifying unit that specifies a specific area within the image, the specific area including the to-be-focused position configured by the focus control unit; and a display control unit that controls the display unit to allow the specific area to be displayed relatively brighter than the other area within the image.

### CROSS REFERENCE TO RELATED APPLICATION

This patent application claims priority from Japanese Patent Application No. 2006-284127 filed in Japan on Oct. 18, 2006, the contents of which are incorporated herein by reference.

### BACKGROUND

1. Technical Field

The present invention relates to an image capture device, an image capture method, a display device, a display method, and a computer readable medium. More particularly, the present invention relates to a capture device and a capture method for capturing an image, a display device and a display method for displaying a captured image, and computer readable media storing thereon program instructions for image capture and display devices.

2. Related Art

A method for driving a liquid crystal display device is proposed as disclosed, for example, in Japanese Patent Application Publication Nos. 2003-195835, 2002-72998, 2002-98957, and 2004-294764. In the method, a brightness difference is provided between the center portion and the peripheral portion of the screen where a video is displayed.

### SUMMARY

However, according to the liquid crystal display device described in Patent Document 1, a subject of great interest for a user is difficult to be viewed by the user when it is located in the peripheral portion.

Therefore, it is an object of an aspect of the present invention to provide a image capture device, a image capture method, a display device, a display method, and a computer readable medium, which are capable of overcoming the above drawbacks accompanying the related art. The above and other objects can be achieved by combinations described in the independent claims. The dependent claims define further advantageous and exemplary combinations of the present invention.

According to the first aspect related to the innovations herein, one exemplary image capture device may include: a image capture unit that captures an image; a focus control unit that controls a to-be-focused position of the image capture unit; a display unit that displays the image; an area specifying unit that specifies a specific area within the image, the specific area including the to-be-focused position configured by the focus control unit; and a display control unit that controls the display unit to allow the specific area to be displayed relatively brighter than the other area within the image.

The focus control unit may include a subject distance calculation unit that calculates a plurality of distances from the image capture device to a subject corresponding respectively to a plurality of to-be-focused points on the image captured by the image capture unit; a to-be-focused position selection unit that selects one of the plurality of to-be-focused points according to the distances calculated by the subject distance calculation unit; and a to-be-focused position adjustment unit that adjusts the to-be-focused position of the image capture unit to be aligned to the one of the to-be-focused points. The area specifying unit may compare a reference distance corresponding to the one of the to-be-focused points selected by the to-be-focused point selection unit with a second distance corresponding to a second one of the to-be-focused points, and may further specify a predetermined area including the second to-be-focused point as a second specific area when the difference between the reference and the second distances exists within a predetermined range. The display control unit may allow the specific areas including the second specific area specified by the area specifying unit to be displayed relatively brighter than the area other than the specific areas within the image.

The area specifying unit may determine the specific areas in order for a sum of the specific areas to be a predetermined amount or less.

The image capture device may further include an object area extraction unit that extracts an object area including the to-be-focused position configured by the focus control unit from the image displayed by the display unit. The area specifying unit may specify the object area as a specific area.

According to the second aspect related to the innovations herein, one exemplary image capture method may include: controlling a to-be-focused position of an image capture unit that captures an image; displaying the image; specifying a specific area within the image, the specific area including the to-be-focused position configured in the controlling of the to-be-focused position; and controlling the displaying of the image to allow the specific area to be displayed relatively brighter than the other area within the image.

According to the third aspect related to the innovations herein, one exemplary computer readable medium storing thereon program instructions executable to implement an image capture device is provided. The image capture device may include: an image capture unit that captures an image; a focus control unit that controls a to-be-focused position of the image capture unit; a display unit that displays the image; an area specifying unit that specifies a specific area within the image, the specific area including the to-be-focused position configured by the focus control unit; and a display control unit that controls the display unit to allow the specific area to be displayed relatively brighter than the other area within the image.

According to the fourth aspect related to the innovations herein, one exemplary display device for displaying an image may include: a display unit that displays the image; an area specifying unit that specifies a specific area within the image, the specific area including a to-be-focused position of the image; and a display control unit that controls the display unit to allow the specific area to be displayed relatively brighter than the other area within the image.

According to the fifth aspect related to the innovations herein, one exemplary display method for displaying a captured image may include: specifying a specific area within the image, the specific area including a to-be-focused position of the image; and controlling the displaying of the image to allow the specific area to be displayed relatively brighter than the other area within the image.

According to the sixth aspect related to the innovations herein, one exemplary computer readable medium storing thereon program instructions executable to implement a display device for displaying a captured image is provided. The display device may include: an area specifying unit that specifies a specific area within the image, the specific area including a to-be-focused position of the image; a display unit that displays the image; and a display control unit that controls the display unit to allow the specific area to be displayed relatively brighter than the other area within the image.

According to an advantage of some aspects of the invention, the user may recognize a focused area at a glance.

### BRIEF DESCRIPTION OF THE DRAWINGS

The summary clause does not necessarily describe all necessary features of the embodiments of the present invention. The above and other features and advantages of the present invention will become more apparent from the following description of the embodiments taken in conjunction with the accompanying drawings, wherein:

FIG. 1 shows an exemplary use environment for an image capture device;

FIG. 2 shows an exemplary block configuration of the image capture device;

FIG. 3 shows an exemplary display unit;

FIG. 4 shows another exemplary display unit;

FIG. 5 shows yet another exemplary display unit;

FIG. 6 shows an exemplary specific area;

FIG. 7 shows another exemplary specific area;

FIG. 8 shows yet another exemplary specific area;

FIG. 9 shows still yet another exemplary specific area; and

FIG. 10 shows an exemplary hardware configuration of a computer connecting to the image capture device.

### DESCRIPTION OF EXEMPLARY EMBODIMENTS

Some aspects of the invention will now be described based on the embodiments, which do not intend to limit the scope of the present invention, but exemplify the invention. All of the features and the combinations thereof described in the embodiment are not necessarily essential to the invention. The same reference numerals may be used in different drawings to identify the same or similar elements.

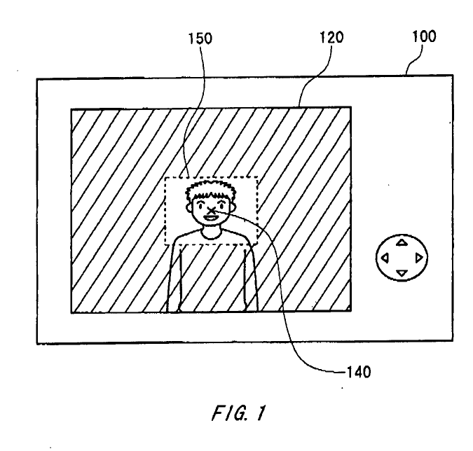

FIG. 1 shows exemplary contents displayed on a monitor or a display unit 120 by an image capture device 100 according to an embodiment of the present invention. The image capture device 100 focuses on a subject a predetermined to-be-focused point 140 appearing within an image capture area when the user presses a shutter release button down halfway. Then, the subject captured in the image capture device 100 is determined with the to-be-focused point 140 being in a focused state, when the user further presses the shutter release button down fully. It should be noted that the term “captured” encompasses any states where the image is taken into the image capture device 100 to be displayed on the display unit 100 so that the term may be applicable to when the shutter release button is pressed down both halfway and fully. Also, the image capture device 100 displays the captured image on the display unit 120 thereof. Here, a predetermined area 150 around the to-be-focused point 140 of the image is displayed by the image capture device 100 to be relatively brighter than the other area within the display unit 120. Since the area including the to-be-focused point 140 is displayed brighter by the image capture device 100, the user may easily recognize which part is focused on and may easily determine whether the focusing procedure is actually performed in an appropriate manner.

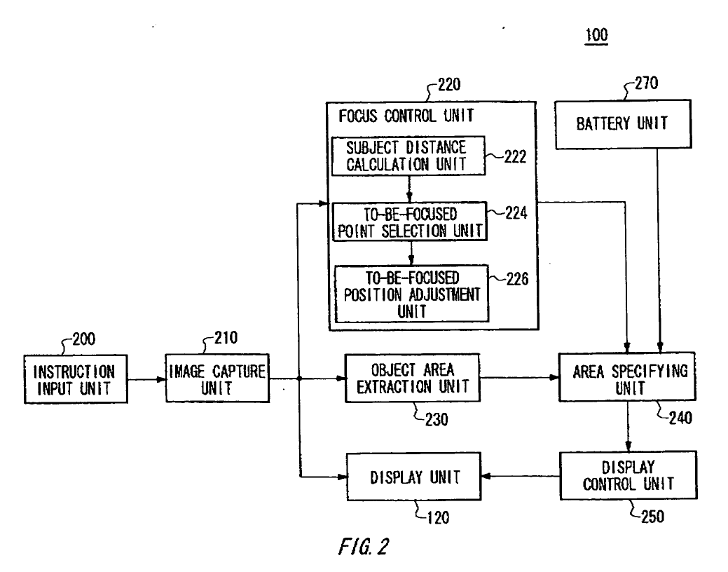

FIG. 2 shows an exemplary block configuration of the image capture device 100. The image capture device 100 includes a display unit 120, an image capture unit 210, an instruction input unit 200, a focus control unit 220, an object area extraction unit 230, an area specifying unit 240, a display control unit 250, and a battery unit 270. The focus control unit 220 includes a subject distance calculation unit 222, a to-be-focused point selection unit 224, and a to-be-focused position adjustment unit 226.

The image capture unit 210 captures an image. The focus control unit 220 controls a to-be-focused position of the image capture unit 210. The area specifying unit 240 specifies a specific area within the image captured by the image capture unit 210. The specific area includes the to-be-focused position configured by the focus control unit 220 when the image capture unit 210 captures the image. The display unit 120 displays the image captured by the image capture unit 210. The display control unit 250 controls the display unit 120 to allow the specific area specified by the area specifying unit 240 to be displayed relatively brighter than the other area.

In particular, the subject distance calculation unit 222 calculates distances between the image capture device 100 and the subject corresponding respectively to a plurality of to-be-focused points on the image captured by the image capture unit 210. The to-be-focused point selection unit 224 selects one from the plurality of to-be-focused points according to the distances to the subject calculated by the subject distance calculation unit 222. The to-be-focused position adjustment unit 226 adjusts the to-be-focused position of the image capture unit 210 to be aligned to the to-be-focused point selected by the to-be-focused point selection unit 224. The area specifying unit 240 compares a reference distance corresponding to the to-be-focused point selected by the to-be-focused point selection unit 224 with a second distance corresponding to a second one of the to-be-focused points. When the difference between the reference and the second distances exists within a predetermined range, the area specifying unit 240 further specifies a predetermined area including the second to-be-focused point as a second specific area. Then, the display control unit 250 displays the specific areas including the second specific area specified by the area specifying unit 240 to be relatively brighter than the area other than the specific areas within the image. Thus, for example, not only a specific area including an in-focus point actually adjusted by the focus control unit 220 but also an area appearing sharp enough may be displayed relatively brighter than the other area according to the image capture device 100.

It should be noted that the area specifying unit 240 may determine the specific areas in order for a sum of the specific areas to be a predetermined amount or less. Also, the area specifying unit 240 may determine the specific areas such that the sum of the specific areas is substantially equal to a sum of other specific areas determined corresponding to other to-be-focused points.

The object area extraction unit 230 extracts an object area, which includes a to-be-focused position configured by the focus control unit 220 when the image capture unit 210 captures an image, from the captured image. The object area extraction unit 230 extracts an object area including a to-be-focused position from the image captured by the image capture unit 210, for example, by applying an edge extraction. Then, the area specifying unit 240 specifies the object area extracted by the object area extraction unit 230 as a specific area.

In particular, the object area extraction unit 230 extracts a person area, which includes the to-be-focused position configured by the focus control unit 220 when the image capture unit 210 captures an image, from the captured image. More particularly, the object area extraction unit 230 extracts the person area including the to-be-focused position by applying a template matching. The template matching is performed between a template configured to take on a shape of a predetermined person and a contour of the object extracted from the image by the edge extraction. Then, the area specifying unit 240 specifies the person area extracted by the object area extraction unit 230 as a specific area.

The object area extraction unit 230 extract a person's face area, which includes a to-be-focused position configured by the focus control unit 220 when the image capture unit 210 captures an image, from the captured image. In particular, the object area extraction unit 230 extracts the person's face area including the to-be-focused position by applying a template matching. The template matching uses a template representing a shape of a predetermined object included in a person's face. The object is exemplified by the eyes, the mouth, the nose, or the like. The template matching is performed between the template and the contour of the object extracted by an edge extraction from the image. The area specifying unit 240 specifies the person's face area extracted by the object area extraction unit 230 as a specific area. According to such controls, only a person area or only a person's face area, for example, may be displayed relatively brighter than the other area by the image capture device 100.

The battery unit 270 includes one or more batteries for supplying power to drive the image capture device 100. The area specifying unit 240 may specify the specific area to be smaller as the battery remaining amount of the battery unit 270 is less.

It should be noted that the display control unit 250 may control the display unit 120 to allow an area nearer to the specific area to be displayed brighter within the area other than the specific area. According to such controls, there may exist a gradation between the specific area and the other area in brightness. Thus, the user may recognize the specific area without sensing of unevenness between the specific area and the other area.

The display unit 120 includes a backlight unit that emits light, and a liquid crystal unit that displays an image by transmitting the light emitted from the backlight unit. Here, the display control unit 250 controls an emission intensity of the backlight unit to be relatively greater for displaying image contents on the specific area, which is displayed on the liquid crystal unit, specified by the area specifying unit 240 than for displaying image contents on the other area displayed on the liquid crystal unit.

In particular, the backlight unit includes a plurality of light-emitting elements that respectively emit light to a plurality of areas on the liquid crystal unit. The liquid crystal unit displays an image by transmitting the light emitted by the light-emitting elements. The display control unit 250 controls an emission intensity of some of the light-emitting elements, which emit light onto an area displayed on the liquid crystal unit corresponding to the specific area, to be relatively greater than that of the other light-emitting elements. The light-emitting elements may include organic electroluminescence elements. As such, it is possible to finely define the specific area.

The backlight unit may include a plurality of light-emitting diodes (LEDs) that respectively emit light to a plurality of areas on the liquid crystal unit. Here, the liquid crystal unit displays an image by transmitting the light emitted from the LEDs. The display control unit 250 controls an emission intensity of one or more of the LEDs to be relatively greater for displaying the specific area on the liquid crystal unit than for displaying the other LEDs.

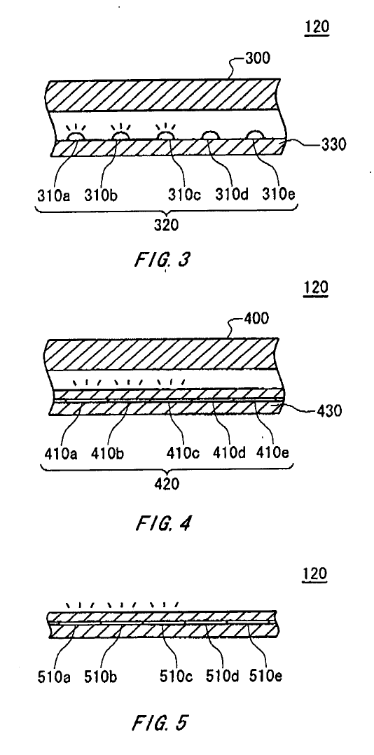

The display unit 120 may include a plurality of light-emitting elements emitting light per pixel. Here, the display control unit 250 controls an emission intensity of some of the light-emitting elements, which are covered in the specific area specified by the area specifying unit 240, to be relatively greater than that for emitting light of pixels included in the other area. The light-emitting elements may include organic electroluminescence elements. It should be noted that details of the display unit 120 configuration will be described below referring to FIGS. 3 to 5.

The area specifying unit 240, the display unit 120, and the display control unit 250 of the components included in the image capture device 100 are possible to be provided as a display device for displaying a captured image. In this case, the area specifying unit 240 specifies a specific area on an image. The specific area includes a to-be-focused position configured when the image is captured. In particular, the area specifying unit 240 obtains the to-be-focused position associated with the image so as to specify a specific area including the to-be-focused position on the image. Then, the display unit 120 displays the image. Here, the display control unit 250 controls the display unit 120 to allow the specific area specified by the area specifying unit 240 to be displayed relatively brighter than the other area within the image. It is obvious that such a display device should be able to include the object area extraction unit 230 and the battery unit 270. Also, such a display device can be used for a small terminal having camera functionality, e.g., a portable camera or a camera built-in portable phone.

FIG. 3 shows an example of the display unit 120. The display unit 120 includes a liquid crystal unit 300 and a backlight unit 320. The backlight unit 320 includes a plurality of LEDs 310a to 310e provided on a substrate 330, hereinafter referred to as LEDs 310. The liquid crystal unit 300 allows the user to recognize the image through controlling a transmission amount of the light emitted from the LEDs 310. Here, the display control unit 250 increases an emission intensity of the LEDs 310a, 310b, and 310c emitting light for the specific area including a to-be-focused position. Thus, the emission intensity of the LEDs 310a, 310b, and 310c becomes relatively greater than that of the other LEDs 310d and 310e. It should be noted that the display control unit 250 may either increase the emission intensity of the LEDs 310a, 310b, and 310c or decrease that of the LEDs 310d and 310e such that the emission intensity of the LEDs 310a, 310b, and 310c can become relatively greater than that of the LEDs 310d and 310e.

FIG. 4 shows another example of the display unit 120. The display unit 120 includes a liquid crystal unit 400 and a backlight unit 420. The backlight unit 420 includes a plurality of organic electroluminescence elements 410a to 410e provided on a substrate 430, hereinafter referred to as organic electroluminescence elements 410. The liquid crystal unit 400 allows the user to recognize the image through controlling a transmission amount of the light emitted from the organic electroluminescence elements 410. Here, the display control unit 250 increases an emission intensity of the organic electroluminescence elements 410a, 410b, and 410c emitting light for the specific area including a to-be-focused position. Thus, the emission intensity of the organic electroluminescence elements 410a, 410b, and 410c becomes relatively greater than that of the other organic electroluminescence elements 410d and 410e. It should be noted that the display control unit 250 may either increase the emission intensity of the organic electroluminescence elements 410a, 410b, and 410c or decrease that of the organic electroluminescence elements 410d and 410e such that the emission intensity of the organic electroluminescence elements 410a, 410b, and 410c can become relatively greater than that of the organic electroluminescence elements 410d and 410e.

It should also be noted that the organic electroluminescence elements 410 are illustrated by way of an example. The light-emitting elements of the present invention are not limited to organic electroluminescence elements. As such, using organic electroluminescence element as light-emitting elements of the backlight unit 420 makes it possible to finely define the specific area and the brightness thereof. Due to this, visibility for the user to recognize the specific area may be improved significantly. Also, unwanted power consumption may be prevented because controlling the brightness per pixel allows for lighting a necessary area only.

It should be noted that the display control unit 250 provides the backlight unit 420 with instructions regarding a light-emitting area and a brightness value by means of an instruction value defined in 8-bit digital data. Moreover, patterns for driving the backlight unit 420 may be maintained as a lookup table in a circuit controlling the backlight unit 420 within the display control unit 250. Also, the display control unit 250 may appropriately switch among the driving patterns for the backlight unit 420 according to external factors, e.g., focus information including a position of a to-be-focused point, illuninance information therearound, image contents, and the like. For example, in the case that the area specifying unit 240 specifies the specific area the ratio of which to the other area is 1:2 and that the display control unit 250 configures brightness values of the specific area and the other area to be 120% and 50% respectively, the overall brightness value is estimated to be approximately 73%. Therefore, the image capture device 100 may achieve a power saving and may allow the specific area of great interest for the user to be displayed in brightness 20% more than usual or to be improved in visibility.

FIG. 5 shows yet another example of the display unit 120. The display unit 120 includes a plurality of organic electroluminescence elements 510a to 510e, hereinafter referred to as organic electroluminescence elements 510. Each of the organic electroluminescence elements 510 emits any of a plurality of color components. A set of the organic electroluminescence elements 510 emitting all the lights of the color components represents a color of one pixel on an image. When the display unit 120 displays a captured image, the display control unit 250 increases an emission intensity of the organic electroluminescence elements 510a, 510b, and 510c emitting light of pixel elements in the specific area including a to-be-focused position. Thus, the emission intensity of the organic electroluminescence elements 510a, 510b, and 510c becomes relatively greater than that of the other organic electroluminescence elements 510d and 510e. It should be noted that the display control unit 250 may either increase the emission intensity of the organic electroluminescence elements 510a, 510b, and 510c or decrease that of the organic electroluminescence elements 510d and 510e such that the emission intensity of the organic electroluminescence elements 510a, 510b, and 510c can become relatively greater than that of the organic electroluminescence elements 510d and 510e.

As such, using organic electroluminescence elements 510 as pixel elements of the display unit 120 makes it possible to finely define the specific area. Due to this, visibility for the user to recognize the specific area may be improved significantly. Also, a power saving may be achieved. It should be noted that the organic electroluminescence elements 510 are illustrated by way of an example. The light-emitting elements of the present invention are not limited to organic electroluminescence elements.

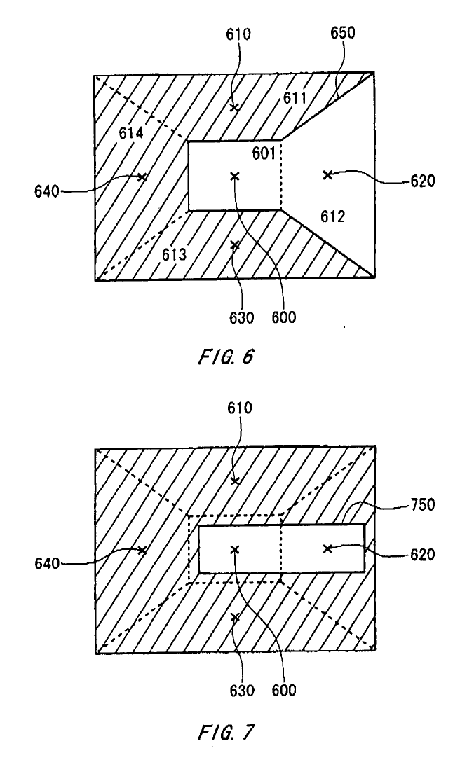

FIG. 6 shows an exemplary specific area that the display control unit 250 allows to be displayed brighter on the display unit 120. As shown in FIG. 6, the area specifying unit 240 specifies not only an area including a to-be-focused point 600 but also a second area including a to-be-focused point 620 as a specific area in an image, for example, captured by the focus control unit 220 that focuses the to-be-focused point 600 on a subject. Thus, the area specifying unit 240 further specifies the area including the to-be-focused point 620 in addition to the area including the to-be-focused point 600, for example when a distance to the subject corresponding to the to-be-focused point 600 is substantially the same as a distance to the subject corresponding to the to-be-focused point 620. Here, the area specifying unit 240 specifies an area defined by a boundary 650. The area consists of a predetermined area for the to-be-focused point 600 and a second predetermined area for the to-be-focused point 620.

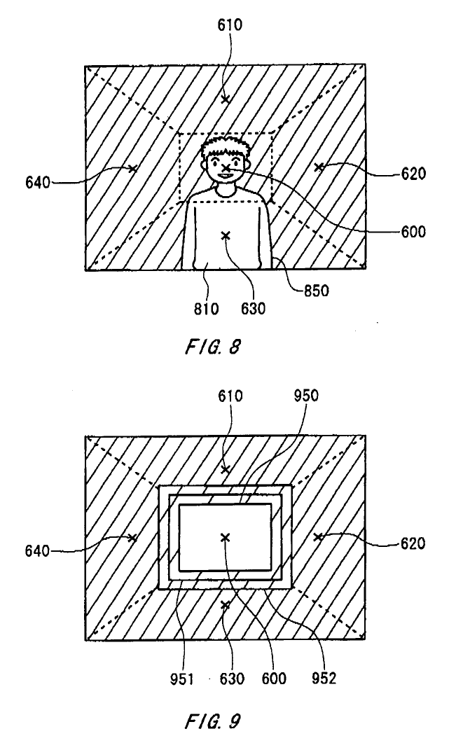

FIG. 7 shows another exemplary specific area that the display control unit 250 allows to be displayed brighter on the display unit 120. Similar to FIG. 6, FIG. 7 shows the specific area when the area specifying unit 240 specifies an area including both of the to-be-focused points 600 and 620 as a specific area. It should be noted that the specific area shown in FIG. 7 is specified smaller than that of FIG. 6 by the area specifying unit 240.

The area specifying unit 240 may specify the specific area such that the total amount of the specific area is substantially equal to that of a predetermined area corresponding to the number of to-be-focused points having to be included in the specific area. If there are many to-be-focused points having to be included in the specific area, a large part of the display unit 120 may be displayed brighter. In this case, advantages that the specific area is more effectively recognized than the other area may not be achieved. However, the area specifying unit 240 limiting the total amount of the specific area to the predetermined area corresponding to the number of to-be-focused points may cause the specific area to be more effectively recognized than the other area.

Besides, the area specifying unit 240 may control the specific area according to the battery remaining amount of the battery unit 270. For example, the area specifying unit 240 may determine the specific area to be smaller as the battery remaining amount of the battery unit 270 is less. This allows the area specifying unit 240 to reduce the battery power consumption rate when the battery remaining amount is less. Also, the display control unit 250 may control the display unit 120 such that the brightness of the specific area is maintained while that of the other area is reduced in the case that the battery remaining amount of the battery unit 270 is less.

FIG. 8 shows yet another exemplary specific area that the display control unit 250 allows to be displayed brighter on the display unit 120. A subject 810 corresponding to the to-be-focused point 600 is a person when an image is captured as the focus control unit 220 focuses the to-be-focused point 600 on the subject 810. The area specifying unit 240 specifies an area of the person as a specific area. For example, the object area extraction unit 230 extracts a contour 850 of the subject including the to-be-focused point 600 by applying an edge extraction. Then, the area specifying unit 240 determines as a specific area the area defined by the contour 850, in the case that matching between a contour extracted by object area extraction unit 230 and a predetermined person pattern is closer than a predetermined level when a pattern matching is performed.

FIG. 9 shows still yet another exemplary specific area that the display control unit 250 allows to be displayed brighter on the display unit 120. As shown in FIG. 9, an area defined by a contour 950 is specified as a specific area by the area specifying unit 240. The specific area includes the to-be-focused point 600 on an image captured as the focus control unit 220 focuses the to-be-focused point 600 on a subject. In this case, the display control unit 250 controls the display unit 120 such that an area defined between the contour 950 and a predetermined second contour 951 outside of the contour 950 should be brighter than another area defined between the second contour 951 and a predetermined third contour 952 outside of the second contour 951. Moreover, the display control unit 250 further controls the display unit 120 such that the area defined between the contours 951 and 952 should be brighter than an area outside of the contour 952.

As such, the display control unit 250 controlling the brightness of the display unit 120 to be less bright in a stepped manner as being away from the specific area allows the user to easily recognize the specific area. As described above referring to FIG. 9, the display control unit 250 controls the brightness to be changed in a stepped manner per each of the plurality of areas outwardly surrounding the specific area. However, it should be obvious that the display control unit 250 may control the brightness of the display unit 120 to be changed per pixel.

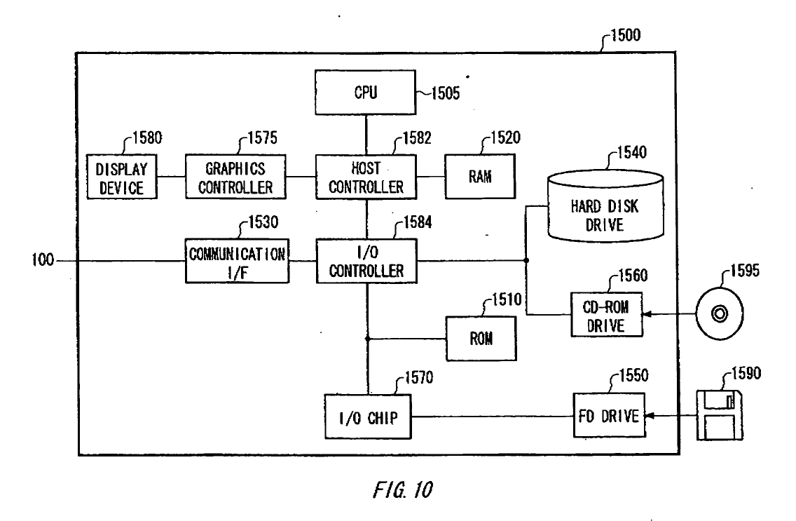

FIG. 10 shows an exemplary hardware configuration of a computer 1500 connecting to the image capture device 100. The computer 1500 generally includes a CPU peripheral unit, an input/output unit, and a legacy input/output unit. The CPU peripheral unit includes an area 1505, a RAM 1520, a graphics controller 1575, and a display device 1580, which are interconnected via a host controller 1582. The input/output unit includes a communication interface 1530, a hard disk drive 1540, and a CD-ROM drive 1560, which are connected with the host controller 1582 via an input/output controller 1584. The legacy input/output unit, which is connected with the input/output controller 1584, includes a ROM 1510, a flexible disk drive 1550, and an input/output chip 1570.

The host controller 1582 is connected with the RAM 1520, the CPU 1505, and the graphics controller 1575 having access to the RAM 1520 with fast transfer rates. The CPU 1505 operates according to a program stored in the ROM 1510 and/or the RAM 1520 to control each unit. The graphics controller 1575 acquires image data generated on a frame buffer provided in the RAM 1520 by the CPU 1505 or the like and displays the same on the display device 1580. Alternatively, the graphics controller 1575 may include therein a frame buffer for storing image data generated by the CPU 1505 or the like.

The input/output controller 1584 is connected with the host controller 1582, the communication interface 1530, the hard disk drive 1540, and the CD-ROM drive 1560 that is a relatively fast input/output device. The hard disk drive 1540 stores a program and/or data used by the CPU 1505 in the computer 1500. The communication interface 1530 communicates with the image capture device 100 and provides the same with a program and/or data. The CD-ROM drive 1560 reads the program and/or data from the CD-ROM 1595 and provides the same to the hard disk drive 1540 and the communication interface 1530 via the RAM 1520.

The input/output controller 1584 is connected with the ROM 1510, and relatively slow input/output devices or the flexible disk drive 1550 and the input/output chip 1570. The ROM 1510 stores a boot program executed by the computer 1500 when starting up, a program depending on the hardware of the computer 1500, and the like. The flexible disk drive 1550 reads a program or data from a flexible disk 1590 and provides the same to the hard disk drive 1540 and the communication interface 1530 via the RAM 1520. The input/output chip 1570 is connected with the flexible disk drive 1550 and other various input/output devices via a parallel port, a serial port a keyboard port, a mouse port, or the like.

A program provided to the communication interface 1530 via the RAM 1520 is stored in a storage medium, e.g., the flexible disk 1590, the CD-ROM 1595, an IC card or the like, and/or provided by the user. The program is read from the storage medium, provided to the communication interface 1530 via the RAM 1520, and transferred to the image capture device 100 via a network. The program transferred to the image capture device 100 is installed on the same and executed.

The program installed and executed on the image capture device 100 allows the same to function as the display unit 120, the image capture unit 210, the instruction input unit 200, the focus control unit 220, the object area extraction unit 230, the area specifying unit 240, the display control unit 250, and the battery unit 270, which are described above referring to FIGS. 1 to 9. Also, the program allows the focus control unit 220 to function as the subject distance calculation unit 222, the to-be-focused point selection unit 224, and the to-be-focused position adjustment unit 226, which are described above referring again to FIGS. 1 to 9.

The program described above may be stored in an external storage medium. Besides the flexible disk 1590 and the CD-ROM 1595, an optical storage medium such as a digital versatile disk (DVD), a phase change rewritable disk (PD) or the like, a magneto optical storage medium such as a mini disk (MD), a tape medium, a semiconductor memory such as an IC card, or the like may be used. Alternatively, a storage device such as a hard disk, a RAM or the like provided on a server system connected with a private communication network or the internet may be used as a storage medium such that a program may be provided to the computer 1500 via the network or the internet.

Also, the computer 1500 may communicate with the display device described referring to FIG. 2 instead of the image capture device 100 so as to provide the display device with a program and/or data. The program installed and executed on the display device may allow the display device to function as the display unit 120, the object area extraction unit 230, the area specifying unit 240, the display control unit 250, and the battery unit 270 described referring to FIG. 2.

Although some aspects of the present invention have been described by way of exemplary embodiments, it should be understood that those skilled in the art might make various modifications or substitutions without departing from the spirit and the scope of the present invention that is defined only by the appended claims. It is obvious from the appended claims that embodiments with such modifications or substitutions also belong to the technical scope of the present invention.

What is claimed is:

1. An image capture device, comprising:
an image capture unit that captures an image;
a focus control unit that controls a to-be-focused position of the image capture unit;
a display unit that displays the image;
an area specifying unit that specifies a specific area within the image, the specific area including the to-be-focused position configured by the focus control unit; and
a display control unit that controls the display unit to allow the specific area to be displayed relatively brighter than the other area within the image.

2. The image capture device as set forth in claim 1, the focus control unit comprising:
a subject distance calculation unit that calculates a plurality of distances from the image capture device to a subject corresponding respectively to a plurality of to-be-focused points on the image captured by the image capture unit;
a to-be-focused position selection unit that selects one of the plurality of to-be-focused points according to the distances calculated by the subject distance calculation unit; and
a to-be-focused position adjustment unit that adjusts the to-be-focused position of the image capture unit to be aligned to the one of the to-be-focused points,
wherein the area specifying unit compares a reference distance corresponding to the one the to-be-focused points selected by the to-be-focused point selection unit with a second distance corresponding to a second one of the to-be-focused points, and further specifies a predetermined area including the second to-be-focused point as a second specific area when the difference between the reference and the second distances exists within a predetermined range, and
wherein the display control unit allows the specific areas including the second specific area specified by the area specifying unit to be displayed relatively brighter than the area other than the specific areas within the image.

3. The image capture device as set forth in claim 2, wherein the area specifying unit determines the specific areas in order for a sum of the specific areas to be a predetermined amount or less.

4. The image capture device as set forth in claim 1, further comprising an object area extraction unit that extracts an object area including the to-be-focused position configured by the focus control unit from the image displayed by the display unit,
wherein the area specifying unit specifies the object area as a specific area.

5. The image capture device as set forth in claim 4, wherein the object area extraction unit extracts a person area including the to-be-focused position configured by the focus control unit from the image displayed by the display unit, and
wherein the area specifying unit specifies the person area as a specific area.

6. The image capture device as set forth in claim 1, further comprising a battery unit including a battery to supply power for driving the same,
wherein the area specifying unit specifies the specific area to be smaller as the battery remaining amount of the battery unit is less.

7. The image capture device as set forth in claim 1, wherein the display control unit controls the display unit to allow an area nearer to the specific area to be displayed brighter within the area other than the specific area.

8. The image capture device as set forth in claim 1, wherein the display unit comprises a backlight unit that emits light and a liquid crystal unit that displays an image by transmitting the light emitted from the backlight unit, and
wherein the display control unit controls an emission intensity of the backlight unit to be greater for displaying image contents on the specific area than for displaying image contents on the other area.

9. The image capture device as set forth in claim 8, wherein the backlight unit comprises a plurality of light-emitting elements that respectively emit light to a plurality of areas on the liquid crystal unit;
wherein the liquid crystal unit displays an image by transmitting the light emitted from the light-emitting elements; and
wherein the display control unit controls an emission intensity of some of the light-emitting elements to be relatively greater than that of the other light-emitting elements.

10. The image capture device as set forth in claim 8, wherein the backlight unit comprises a plurality of light-emitting diodes that respectively emit light to a plurality of areas on the liquid crystal unit,
wherein the liquid crystal unit displays an image by transmitting the light emitted from the light-emitting diodes, and
wherein the display control unit controls an emission intensity of some of the light-emitting diodes to be relatively greater for displaying the specific area on the liquid crystal unit than for displaying the other light-emitting diodes.

11. The image capture device as set forth in claim 1, wherein the display unit comprises a plurality of light-emitting elements to display an image, each of the light-emitting elements emitting light per pixel, and
wherein the display control unit controls an emission intensity of some of the light-emitting elements to be relatively greater for emitting light of pixels included in the specific area than for emitting light of pixels included in the other area.

12. The image capture device as set forth in claim 11, wherein the light-emitting elements comprise organic electroluminescence elements.

13. An image capture method, comprising:
controlling a to-be-focused position of an image capture unit that captures an image;
displaying the image;
specifying a specific area within the image, the specific area including the to-be-focused position configured in the controlling of the to-be-focused position; and
controlling the displaying of the image to allow the specific area to be displayed relatively brighter than the other area within the image.

14. A computer readable medium storing thereon program instructions executable to implement an image capture device, the image capture device comprising:
an image capture unit that captures an image;
a focus control unit that controls a to-be-focused position of the image capture unit;
a display unit that displays the image;
an area specifying unit that specifies a specific area within the image, the specific area including the to-be-focused position configured by the focus control unit; and
a display control unit that controls the display unit to allow the specific area to be displayed relatively brighter than the other area within the image.

15. A display device for displaying an image, comprising:
a display unit that displays the image;
an area specifying unit that specifies a specific area within the image, the specific area including a to-be-focused position of the image; and
a display control unit that controls the display unit to allow the specific area to be displayed relatively brighter than the other area within the image.

16. A display method for displaying a captured image, comprising:
specifying a specific area within the image, the specific area including a to-be-focused position of the image; and
controlling the displaying of the image to allow the specific area to be displayed relatively brighter than the other area within the image.

17. A computer readable medium storing thereon program instructions executable to implement a display device for displaying a captured image, the display device comprising:
an area specifying unit that specifies a specific area within the image, the specific area including a to-be-focused position of the image;
a display unit that displays the image; and
a display control unit that controls the display unit to allow the specific area to be displayed relatively brighter than the other area within the image.
